(19) United States
(12) Patent Application Publication
(10) Pub. No.: US 2007/0081063 A1
(43) Pub. Date: Apr. 12, 2007

(54) Ultraviolet curable ink set and image recording method

(75) Inventors: Keitaro Nakano, Matsumoto-shi (JP); Takashi Oyanagi, Shazurl-shi (JP)

Correspondence Address: LADAS & PARRY, 26 West 61 Street, New York, NY, 10023, US

(73) Assignee: SEIKO EPSON CORPORATION

(21) Appl. No.: 11/544,815

(22) Filed: Oct. 6, 2006

(30) Foreign Application Priority Data
Oct. 11, 2005 (JP) P.2005-296218

(51) Int. Cl. G01D 11/00

(52) U.S. Cl. 347/100

(57) ABSTRACT

The present invention provides an ultraviolet curable ink set comprising: a white ink composition containing at least a white pigment and a polymerizable compound; and a color ink composition containing at least a coloring material of a color other than white and a polymerizable compound, wherein at least one of the white ink composition and the color ink composition contains a polymerization initiator. Also disclosed is an image recording method using the ultraviolet curable ink set.

### FIELD OF THE INVENTION

The present invention relates to an ultraviolet curable ink set and an image recording method using the ink set. More particularly, it relates to a two-component ultraviolet curable ink set that can record a satisfactory image with the desired color even on a transparent recoding medium, and an image recording method using the ink set.

### BACKGROUND OF THE INVENTION

An ink-jet recording method is a printing method that flies droplets of an ink composition, and adhering the same to a recording medium such as paper, thereby conducting printing. This ink-jet recording method has the characteristic that an image having high resolution and high definition can be printed at high rate. In general, an ink composition used in the ink-jet recording method comprises an aqueous solvent as a main component, a coloring component, and a wetting agent, such as glycerin, for the purpose of preventing clogging.

On the other hand, in the case of printing on a recording medium such as paper or fabric into which an aqueous ink composition hardly penetrates; and plates or films produced from materials of metals or plastics (resins such as phenol, melamine, vinyl chloride, acryl and polycarbonate) into which an aqueous ink composition does not penetrate, it is required for the ink composition to contain a component that can stably fix a colarant to the recording medium.

For such a requirement, an ultraviolet curable ink-jet ink comprising a colorant, an ultraviolet curing agent (polymerizable compound) and a (photo)polymerization initiator is disclosed (for example, see Patent Document 1). It is disclosed that according to this ink, ink bleeding to a recording medium can be prevented, and image quality can be improved.

Patent Document 1: U.S. Pat. No. 5,623,001

### SUMMARY OF THE INVENTION

However, where an image is recorded on a transparent recording medium (hereinafter referred to as “medium” for simplicity) with the ultraviolet curable ink disclosed in Patent Document 1, the image obtained generates see-through phenomenon of other color from the back, and thus could not be satisfactory.

The present invention is to overcome the above disadvantages in the background art, and provide an ultraviolet curable ink set and an image recording method that can record a satisfactory image with the desired color even in the case of using a transparent recording medium.

The present inventions have made extensive investigations. As a result, the above objects have been achieved by employing the following constitutions, thereby leading to the accomplishment of the present invention.

That is, the present invention is as follows.

(1) An ultraviolet curable ink set comprising:

a white ink composition containing at least a white pigment and a polymerizable compound; and

a color ink composition containing at least a coloring material of a color other than white and a polymerizable compound,

wherein at least one of the white ink composition and the color ink composition contains a polymerization initiator.

(2) The ultraviolet curable ink set as described in the above (1), wherein the white ink composition contains the white pigment in an amount of from 0.1 to 25 mass %.

(3) The ultraviolet curable ink set as described in the above (1) or (2), wherein the polymerizable compound contained in the white ink composition comprises at least one of a monofunctional monomer and a bifunctional monomer, and the polymerizable compound contained in the color ink composition comprises at least one of a monofunctional monomer, a bifunctional monomer, a polyfunctional monomer and an oligomer.

(4) The ultraviolet curable ink set as described in the above (1), containing N-vinylformamide as a monofunctional monomer.

(5) The ultraviolet curable ink set as described in the above (1), containing at least two color ink compositions.

(6) An image recording method comprising:

allowing a white ink composition to adhere to a recording medium;

allowing a color ink composition to adhere onto the adhered site of the white ink composition; and

irradiating the adhered site of the ink compositions with ultraviolet light,

wherein the white ink composition contains at least a white pigment and a polymerizable compound, the color ink composition contains at least a coloring material of a color other than white and a polymerizable compound, and at least one of the white ink composition and the color ink composition contains a polymerization initiator.

The ultraviolet curable ink set of the present invention comprises a white ink composition containing a white pigment (hereinafter referred to as an “ink composition A”) and a color ink composition containing a coloring material of a color other than white (hereinafter referred to as an “ink composition B”), and a polymerization initiator may be contained in either of the white ink composition or the color ink composition, or may be contained in both.

The white pigment in the white ink composition is required to be added in a considerable amount in order to obtain the desired whiteness, and the amount of less than 0.1 mass % may not obtain the desired shielding of the transparent medium. Further, the amount exceeding 25 mass % gives rise to the problems on viscosity, dispersion stability and the like of the ink composition, and such an ink composition is not suitable for use as an ink-jet ink. For this reason, it is preferable that a monofunctional or bifunctional monomer having relatively low viscosity is used in the white ink composition, and N-vinylformamide is used as the monofunctional monomer. The polymerizable compound contained in the color ink composition is a monofunctional monomer, a bifunctional monomer, a polyfunctional monomer and/or an oligomer.

When printing on a transparent medium, the white ink composition is adhered, and the color ink composition other than white is then adhered, followed by irradiation with ultraviolet light, thereby forming a cured image. By this, an image is not seen-through even on a transparent recording medium, thereby improving printing quality. Further, because the transparent medium is uniformly shielded with the white pigment, image deterioration due to see-through phenomenon from the back can be prevented.

### BRIEF DESCRIPTION OF THE DRAWING

FIG. 1 is a view showing an ink-jet recording apparatus preferably used to carry out an ink-jet recording method using the ultraviolet curable ink set for ink-jet of the present invention.

The reference numerals used in the drawing denote the followings, respectively.
1a: recording head,
1b: recording head,
2a: ink tank,
2b: ink tank,
3: tube,
4: carriage,
5: motor,
6: timing belt,
7: recording medium,
8: platen,
9: guide,
10: cap,
11: suction pump,
12: tube,
13: waste ink tank,
14: heater,
15: ultraviolet irradiation means

### DETAILED DESCRIPTION OF THE INVENTION.

The ultraviolet curable ink set for ink-jet and the image recording method of the present invention are described in detail below.

The ultraviolet curable ink set of the present invention comprises a white ink composition containing a white pigment (ink composition A) and a color ink composition containing a coloring material of a color other than white (ink composition B), and is characterized in that it is a two-component (separation type) ultraviolet curable ink set containing a polymerization initiator in at least one of the white ink composition and the color ink composition.

The white pigment contained in the white ink composition used in the ultraviolet curable ink set of the present invention is not particularly limited. Examples of the white pigment include light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, aluminum hydroxide, alumina, lithopone, zeolite, synthetic smectite, magnesium carbonate and magnesium hydroxide.

The coloring material contained in the color ink composition used in the ultraviolet curable ink set of the present invention may be any of dyes and pigments. However, pigments are advantageous from the point of durability of a printed matter.

The dyes used in the present invention can use various dyes generally used in ink-jet recording, such as a direct dye, an acidic dye, an edible dye, a basic dye, a reactive dye, a disperse dye, a vat dye, a soluble vat dye and a reactive vat dye.

The pigments used in the present invention can use inorganic pigments and organic pigments without any particular limitation.

Examples of the inorganic pigment that can be used include titanium oxide, iron oxide and carbon black produced by the conventional methods such as a contact method, a furnace method and a thermal method. Examples of the organic pigment that can be used include an azo pigment (including azo lake, insoluble azo pigment, condensed azo pigment and chelate azo pigment), a polycyclic pigment (for example, phthalocyanine pigment, perylene pigment, perynone pigment, anthraquinone pigment, quinacridone pigment, dioxazine pigment, thioindigo pigment, isoindolinone pigment and quinophthalone pigment), a dye chelate (for example, basic dye chelate and acidic dye chelate), a nitro dye, a nitroso dye and aniline black.

According to the preferred embodiment of the present invention, those pigments may be made present in the ink composition in the form of a pigment dispersion obtained by dispersing the pigment in an aqueous medium with a dispersing agent or a surfactant. A dispersing agent presently used to prepare a pigment dispersion, such as a polymeric dispersing agent, can be used as the preferable dispersing agent.

The amount of the white pigment added in the white ink composition is in a range of preferably from about 0.1 to 25 mass %, and more preferably in a range of from about 0.5 to 15 mass %.

Where the amount of white pigment added is less than 0.1 mass %, uniform shielding of a transparent medium is not sufficient, and where it exceeds 25%, problems on viscosity, dispersion stability and the like of the ink composition may cause.

The amount of the coloring material added in the color ink composition is in a range of preferably from about 0.1 to 25 mass %, and more preferably in a range of from about 0.5 to 15 mass %.

Two kinds or more of the color ink composition may be contained in the ink composition.

A wetting agent, a penetrating solvent, a pH regulator, an antiseptic, a fungicide and the like may be added to the white ink composition and the color ink composition of the present invention as the conventional other components that can be used in an aqueous ink.

The polymerizable compound and the polymerization initiator used in the ultraviolet curable ink set of the present invention are described below.

The polymerizable compound used in the ultraviolet curable ink set of the present invention is not particularly limited so long as it is polymerized by radicals or ions generated from a photopolymerization initiator.

The polymerizable compound includes monomers. The monomer means a molecule capable of becoming a structural unit in a basic structure of a polymer. The monomer used in the present invention is called a photopolymerizable monomer, and includes a monofunctional monomer, a bifunctional monomer and a polyfunctional monomer. Any of those can be used. It is preferable that any monomers have PII value (Primary Irritation Index) of 2 or less.

As described before, the content of the white pigment in the white ink composition is that the white pigment is required to be added in a considerable amount as compared with the content of the coloring material in the color ink composition in order to uniformly shield a transparent medium with the white pigment, and as a result, viscosity of the white ink composition increases. Where ink viscosity increases, such an ink is not suitable as an ink-jet ink. For this reason, a monofunctional monomer and a bifunctional monomer that have relatively low viscosity are used in the white ink composition. In the color ink composition, a monofunctional monomer, a bifunctional monomer, a polyfunctional monomer and/or an oligomer are used as the polymerizable compound.

Monofunctional monomers, bifunctional monomers and polyfunctional monomers, having the PII value of 2 or less used in the ultraviolet curable ink set of the present invention are exemplified in Table 1 below.

TABLE 1

| | | |
|---|---|---|
| | Viscosity | |
| Material Name | (mPa · s) | P.I.I |

Monofunctional monomer

| | | |
|---|---|---|
| N-Vinylformamide (NVF, Beamset 770, | 4.3 | 0.4 |
| Arakawa Chemical) | | |
| (2-Methyl-2-ethyl-1,3-dioxolan-4-yl)methyl | 5.1 | 1.3 |
| acrylate (MEDOL-10, Osaka Organic Chemical) | | |
| (2-Methyl-2-isobutyl-1,3-dioxolan-4-yl)methyl | 5.3 | 1.0 |
| acrylate (MIBDOL-10, Osaka Organic Chemical) | | |
| Phenoxyethyl acrylate (Biscoat #192, Osaka | 3.3 | 1.7 |
| Organic Chemical) | | |
| Isobonyl acrylate (IBXA, Osaka Organic | 2.6 | 0.6 |
| Chemical) | | |
| Methoxydiethylene glycol monoacrylate | 2 | 0.7 |
| (Blenmer PME-100, NOF Corporation) | | |
| Acryloyl morpholine (ACMO, Kohjin Co.) | 12 | 0.5 |

Bifunctional monomer

| | | |
|---|---|---|
| Ethylene glycol dimethacrylate (Light-Ester EG, | 3 | 0.6 |
| Kyoeisha Chemical Co.) | | |
| Diethylene glycol dimethacrylate (Light-Ester | 5 | 0.5 |
| 2EG, Kyoeisha Chemical Co.) | | |
| Tripropylene glycol diacrylate (Acronix | 12 | 1.6 |
| M-220, Toagosei Co.) | | |
| 1,9-Nonanediol diacrylate (Biscoat #260, | 21 | 2.0 |
| Osaka Organic Chemical) | | |
| Polyethylene glycol #400 diacrylate | 58 | 0.4 |
| (NK ester A400, Shin-Nakamura Chemical Co.) | | |
| Tetraethylene glycol dimethacrylate (NK | 14 | 0.5 |
| ester 4G, Shin-Nakamura Chemical Co.) | | |
| 1,6-Hexanediol dimethacrylate (NK ester | 6 | 0.5 |
| HD-N, Shin-Nakamura Chemical Co.) | | |
| Neopentyl glycol dimethacrylate (NK ester | 7 | 0.0 |
| NPG, Shin-Nakamura Chemical Co.) | | |
| 2-Hydroxy1,3-dimethacryloxypropane (NK | 37 | 0.6 |
| ester 701, Shin-Nakamura Chemical Co.) | | |

Polyfunctional monomer

| | | |
|---|---|---|
| Trimethylolpropane (NK ester TMPT, | 42 | 0.8 |
| Shin-Nakamura Chemical Co.) | | |
| Trimethylolpropane PO adduct triacrylate | 55 | 1.5 |
| (Biscoat #360, Osaka Organic Chemical Co.) | | |
| Trimethylolpropane PO adduct triacrylate | 60 | 0.1 |
| (New Frontier TMP-3P, Dai-Ichi Kogyo | | |
| Seiyaku Co.) | | |
| Glycerin PO adduct triacrylate (Biscoat | 75 | 0.8 |
| #GPT, Osaka Organic Chemical) | | |

Viscosity in the above Table is a measurement value at 25° C.

Preferable polymerizable compound is N-vinylformamide, isobonyl acrylate, phenoxyethyl acrylate, acryloyl morpholine or allyl glycol, that are a monofunctional monomer.

Further, as described before, other than the above-described monomers, an oligomer may be contained as the polymerizable compound of the color ink composition of the present invention.

The oligomer that can be used in the color ink composition of the present invention is a molecule having a medium size of relative molecular mass, and has a structure constituted of small times, generally 2 to 20 times, of a repeating substantially or conceptually obtained from a molecule having small relative molecular mass. Further, the oligomer used in the present invention is called a photopolymerizable prepolymer, a base lysine or an acrylic oligomer.

The oligomer has one to several polymerizable functional groups, and therefore, has the property to induce polymerization reaction with monomers or the like by ultraviolet irradiation and the like, thereby crosslinking and polymerizing.

The polymerization initiator contained in at least one of the white ink composition and the color ink composition of the present invention is a compound that absorbs ultraviolet light in a region of about 250 to 450 nm to generate radicals or ions, thereby initiating polymerization of the polymerizable compound.

Representative examples of the photopolymerization initiator used in the present invention include benzoin methyl ether, benzoin ethyl ether, isopropyl benzoin ether, isobutyl benzoin ether, 1-phenyl-1,2-propanediol-2-(o-ethoxycarbonyl)oxime, benzyl, diethoxyacetophenone, benzophenone, chlorothioxanthone, 2-chlorothioxanthone, isopropylthioxanthone, 2-methylthioxanthone, polychloropolyphenyl and hexaxhlorobenzene. Of those, isobutyl benzoin ether and 1-phenyl-1,2-propanediol-2-(o-ethoxycarbonyl)oxime are preferable.

Additionally, photopolymerization initiators commercially available in the trade names of Vicure 10 and 30 (products of Stauffer Chemical), Irgacure 127, 184, 500, 651, 2959, 907, 369, 379, 754, 1700, 1800, 1850, 819, OXE01, Darocur 1173, TPO and ITX (products of Ciba Specialty Chemicals), Quantacure CTX (a product of Aceto Chemical), Kayacure DETX-S (a product of Nippon Kayaku Co.) and ESACURE KIP150 (a product of Lamberti) can be used.

The ink composition of the present invention (white ink composition or color ink composition) may contain a polymerization accelerator.

The polymerization accelerator contained in the ink composition of the present invention is not particularly limited, and include Darocur EHA and EDB (products of Ciba Specialty Chemicals).

Other polymerization accelerators include fine particles having a polymerizable functional group.

Action mechanism of the fine particles having a polymerizable functional group is not clear, but it is estimated as follows. By containing the fine particles in the ink composition, the monomer component adsorbs on the surface of the fine particles, and because radicals generated by the polymerization initiator do not escape, the monomer adsorbed on the surface of the fine particles contributes to polymerization with good efficiency.

The fine particles having a polymerizable functional group are not particularly limited, and are generally called a extender pigment. Inorganic compounds such as silica, alumina, titania and calcium oxide are exemplified, and in particular, transparent compounds such as silica and alumina can suitably be used.

Further, the polymerizable functional group possessed by the fine particles is not particularly limited, and includes an acryloyl group and a methacryloyl group. Additionally, it is possible to be present in a form of a polymerizable functional group having at least one double bond.

The size of the fine particles is not particularly limited, but the particles having a particle diameter of from 10 to 100 nm are preferable.

A method for preparing the fine particles having a polymerizable functional group is not particularly limited, and the example thereof includes a method of preparing silane series fine particles having many hydroxyl groups and the like by sol gel reaction of a silane compound such as silanol, and reacting the fine particles with a compound capable of imparting the polymerizable functional group to the hydroxyl group.

The content of the fine particles having a polymerizable functional group in the ink composition of the present invention is not particularly limited, and should appropriately be selected depending on use embodiment and condition, relationship between viscosity and polymerizability of the ink composition, and the like. However, the content is preferably 10 mass % or less to the total mass of the ink composition.

The ink composition of the present invention may contain an aqueous solvent. Additionally, a polyvalent metal salt, polyallylamine or its derivative, a wetting agent, a pH regulator, an antiseptic, a fungicide and the like may be added as optional components to the ink composition.

A polymerization inhibitor in an amount of from 200 to 20,000 ppm can be added as other component to the ink composition of the present invention in order to increase its storage stability. An ultraviolet curing ink is preferably heated to decrease its viscosity, and then injected. Therefore, it is preferable to incorporate the polymerization inhibitor in the ink composition in order to prevent head clogging and the like due to heat polymerization.

Besides, if required and necessary, surfactants, leveling additives, matte agents, polyester resins for adjusting film properties, polyurethane resins, vinyl resins, acrylic resins, rubber resins and waxes can be added.

Further, it is possible to add a slight amount of an organic solvent in order to improve adhesion with a recording medium. In this case, it is effective to add the organic solvent in an amount of a range such that the problems on solvent resistance and VOC do not occur, and such an amount is 5% or less, and preferably 3% or less. However, it is more preferable that the ink composition of the present invention is non-solvent.

It is preferable in use that the ink composition of the present invention has viscosity of 10 mPa·s or less at 25° C.

An ink-jet recoding method using the ultraviolet curable ink set of the present invention comprises discharging the white ink composition on a recording medium, immediately discharging the color ink composition, and then irradiating with ultraviolet light.

Irradiation amount of ultraviolet light is in a range of from 10 to 10,000 mJ/cm² or less, and preferably from 50 to 6,000 mJ/cm². The ultraviolet irradiation amount in a range of such an extent enables curing reaction to conduct sufficiently.

The ultraviolet irradiation means include lamps such as a metal halide lamp, a xenon lamp, a carbon arc lamp, a chemical lamp, a low pressure mercury lamp and a high pressure mercury lamp. For example, the ultraviolet irradiation can be conducted using commercially available lamps such as H lamp, D lamp and V lamp, products of System Co.

Further, the ultraviolet irradiation can be conducted with ultraviolet light-emitting semiconductor elements such as an ultraviolet light-emitting diode (ultraviolet LED) and ultraviolet light-emitting semiconductor laser.

In the ink-jet recoding method using the ultraviolet curable ink set of the present invention, heating may be conducted before, simultaneous with or after the ultraviolet irradiation. Examples of the heating include a method of heating by contacting a heat source with a recording medium, and a method of heating without contacting with a recording medium by irradiating with infrared light or microwave (electromagnetic wave having maximal wavelength of about 2,450 MHz), or blowing hot air.

A recording apparatus for carrying out the ink-jet recoding method using the ultraviolet curable ink set of the present invention is described below.

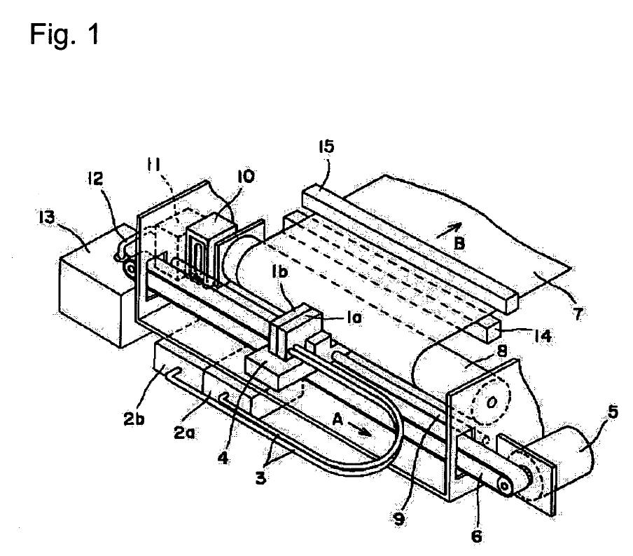

The ink-jet recording apparatus shown in FIG. 1 is constituted of means for adhering the white ink composition and the color ink composition to a recording medium, driving system of the means for adhering those, means for moving the recording medium, means for irradiating the recording medium with ultraviolet light and heating the same, and cleaning means.

A recording heat 1a (and 1b) connected to an ink tank 2a having a white ink composition and an ink tank 2b having a color ink composition through a tube 3 moves to A direction shown by an allow by means of a timing belt 6 driven by a motor 5 along a carriage 4. During moving, the white ink is discharged from nozzle area of the recording head 1a, and is adhered to a recording medium 7 located at a position facing the recording head 1a by means of a platen 8 and a guide 9. The recording medium 7 is traveled to a paper feed direction shown by arrow B in a predetermined amount. During traveling, the recording head 1a (and 1b) moves to a reverse direction of the arrow A, and returns to a left extremity of the recording medium 7. The color ink composition is discharged from a nozzle of the recording head 1b to the recording medium already having the white ink composition adhered thereto, thereby conducting printing. The printed recording medium 7 is further traveled to the paper feed direction shown by the arrow B in a predetermined amount, and undergoes ultraviolet irradiation by an ultraviolet irradiation means 15 and heat treatment by a heater 14. The white ink composition and the color ink composition induce curing reaction on a surface of the recording medium 7 having undergone those treatments, and a colorant fixes on the recording medium 7. The recording medium 7 having printing treatment applied thereto is further traveled to the paper feed direction shown by the arrow B. The present apparatus has a cap 10 having a suction pump 11 connected thereto, and a cleaning operation is conducted by those mechanisms. The ink composition sucked and the like are reserved in a waste ink tank 13 through a tube 12.

### EXAMPLES

The present invention will be illustrated in greater detail with reference to the following Examples, but the invention should not be construed as being limited thereto.

1. White Pigment, Surface-treated Titanium Dioxide and Production of its Dispersion

(1) Preparation of Surface-treated Titanium Dioxide

The following compounds are added to 100 parts by weight of aqueous titanium oxide produced by a sulfuric acid method.

| | |
|---|---|
| Ammonium phosphate | 0.30 part by weight |
| Potassium sulfate | 0.30 part by weight |
| Aluminum sulfate | 0.30 part by weight |

A mixture having the above composition was heated to 1,020° C. in a rotary muffle furnace, thereby preparing a surface-treated titanium dioxide.

The surface-treated titanium dioxide prepared was anatase type, and its average particle diameter was 0.13 μm.

(2) Preparation of Titanium Dioxide Slurry

1,500 g of the surface-treated titanium dioxide fine particles and 1,000 g of isopropyl alcohol (hereinafter referred to as “IPA”) were mixed, and zirconium beads (1.0 mm) in an amount of 1.5 times the resulting slurry were added. After dispersing, the beads were removed to obtain 60 wt % IPA dispersion of titanium dioxide fine particles for use in a white ink for ink-jet.

(3) Preparation of Monomer Dispersion

140 parts by weight of N-vinyl formamide and 100 parts by weight of IPA dispersion obtained above were placed in a 300 ml round-bottom flask. IPA was distilled off using a rotary evaporator to obtain a monomer dispersion containing 30 wt % of titanium dioxide fine particles.

2. Preparation of Ultraviolet Curable Ink Set for Ink-jet

The Examples and the Comparatives were that a white ink composition (ink composition A) and a color ink composition (ink composition B) each having the composition shown in Table 2 below were prepared using the titanium dioxide monomer dispersion prepared by the method described above. The ink composition A in the Comparative Examples is a composition in which the titanium dioxide monomer dispersion (white pigment) was removed from the ink composition A of the Examples.

TABLE 2

| | Example | | | | | Comparative Example | | | | |
|---|---|---|---|---|---|---|---|---|---|---|
| | Ink composition A | Ink composition B | | | | Ink composition A | Ink composition B | | | |
| N-vinylformamide | 5 | 21.9 | 21.6 | 21.8 | 21.8 | 25 | 21.0 | 21.6 | 21.8 | 21.8 |
| Allyl glycol | | 41 | 41 | 41 | 41 | | 41 | 41 | 41 | 41 |
| Tripropylene glycol diacrylate | 69 | | | | | 69 | | | | |
| Trimethylol propane triacrylate (PO adduct) | | 33 | 33 | 33 | 33 | | 33 | 33 | 33 | 33 |
| Irgacure 1800 | 5 | | | | | 5 | | | | |
| Darocur EHA | 1 | 1 | 1 | 1 | 1 | 1 | 1 | 1 | 1 | 1 |
| Titanium oxide monomer dispersion* | 20 | | | | | | | | | |
| Pigment black-7 | | 3 | | | | | 3 | | | |
| Pigment blue-15:3 | | | 3 | | | | | 3 | | |
| Pigment violet-19 | | | | 3 | | | | | 3 | |
| Pigment yellow-155 | | | | | 3 | | | | | 3 |
| Dispersing agent (polyoxyalkylene polyalkylene | | 0.1 | 0.4 | 0.2 | 0.2 | | 0.1 | 0.4 | 0.2 | 0.2 |
| polyamine) | | | | | | | | | | |

The numerical value in the Table means “part by mass”.

3. Printing Test

Using an ink-jet printer PX-G900, a product of Seiko Epson Corporation, the above ink compositions A and B were charged in a separate nozzle line, respectively, and 5 (inch)×5 (inch) solid pattern printing was carried out under the condition of discharging under ordinary temperature and ordinary pressure. Back of A4 size OHP film (OHP sheet only, a product of Seiko Epson Corporation) was used as a recording medium. Printing and curing treatment were simultaneously conducted under the curing condition that the accumulated light intensity is 1,200 mJ/cm², by an ultraviolet irradiation apparatus placed on a paper discharge port.

The ultraviolet irradiation apparatus used was an apparatus (ultraviolet LED: peak wavelength 365 nm, a product of Nichia Corporation) having an ultraviolet irradiation efficiency per unit area of 20 mW/cm².

The printed matters of the Examples and the Comparative Examples were confirmed. As a result, the image in the Examples using the white pigment was less seen-through, and printing quality was improved.

While the present invention has been described in detail and with reference to specific embodiments thereof, it will be apparent to one skilled in the art that various changes and modifications can be made therein without departing from the spirit and scope thereof.

This application is based on Japanese Patent Application No. 2005-296218 filed Oct. 11, 2005, and the contents thereof are herein incorporated by reference.

1. An ultraviolet curable ink set comprising:
a white ink composition containing at least a white pigment and a polymerizable compound; and
a color ink composition containing at least a coloring material of a color other than white and a polymerizable compound,
wherein at least one of the white ink composition and the color ink composition contains a polymerization initiator.

2. The ultraviolet curable ink set as claimed in claim 1, wherein the white ink composition contains the white pigment in an amount of from 0.1 to 25 mass %.

3. The ultraviolet curable ink set as claimed in claim 1, wherein the polymerizable compound contained in the white ink composition comprises at least one of a monofunctional monomer and a bifunctional monomer, and the polymerizable compound contained in the color ink composition comprises at least one of a monofunctional monomer, a bifunctional monomer, a polyfunctional monomer and an oligomer.

4. The ultraviolet curable ink set as claimed in claim 3, containing N-vinylformamide as a monofunctional monomer.

5. The ultraviolet curable ink set as claimed in claim 1, containing at least two color ink compositions.

6. An image recording method comprising:
allowing a white ink composition to adhere to a recording medium;
allowing a color ink composition to adhere onto the adhered site of the white ink composition; and
irradiating the adhered site of the ink compositions with ultraviolet light,
wherein the white ink composition contains at least a white pigment and a polymerizable compound, the color ink composition contains at least a coloring material of a color other than white and a polymerizable compound, and at least one of the white ink composition and the color ink composition contains a polymerization initiator.

7. The ultraviolet curable ink set as claimed in claim 2, wherein the polymerizable compound contained in the white ink composition comprises at least one of a monofunctional monomer and a bifunctional monomer, and the polymerizable compound contained in the color ink composition comprises at least one of a monofunctional monomer, a bifunctional monomer, a polyfunctional monomer and an oligomer.

8. The ultraviolet curable ink set as claimed in claim 7, containing N-vinylformamide as a monofunctional monomer.
